(19) United States
(12) Patent Application Publication
(10) Pub. No.: US 2013/0268337 A1
(43) Pub. Date: Oct. 10, 2013

(54) Method and/or system for extending payment system architectures and/or order processing systems to assign merchant funded incentive options to customers performing a mobile remote check deposit capture (MRDC) routine from a smart mobile device to facilitate online commerce, online-to-offline (O2O) commerce and mobile commerce.

(71) Applicant: Anthony Morello, Canton, OH (US)

(72) Inventor: Anthony Morello, Canton, OH (US)

(21) Appl. No.: 13/591,415

(22) Filed: Aug. 22, 2012

Related U.S. Application Data
(60) Provisional application No. 61/528,297, filed on Aug. 29, 2011.

(51) Int. Cl. G06Q 20/10

(52) U.S. Cl. CPC G06Q 20/108
USPC 705/14.23

(57) ABSTRACT

Method and/or system for extending payment system architectures and/or order processing systems to assign merchant funded incentive options to customers performing a mobile remote check deposit capture (MRDC) routine from a smart mobile device to facilitate online commerce, online-to-offline (O2O) commerce and mobile commerce includes:
a) means for Receiving Check, Geographic Location, Device and Payment Instrument Information
b) means for Presenting Third Party Merchant Funded Incentive Offers
c) means for Receiving Confirmation of Acceptance of Merchant Funded Incentive Offer
d) means for Parsing Confirmation of Acceptance of Merchant Funded Incentive Offer
e) means for Collecting Remittance Funds
f) means for Establishing Payment Instrument and Delivery Information
g) means for Generating an Order
h) means for Submitting an Order to Merchant
i) means for Delivering an Order Confirmation

### CROSS REFERENCE TO RELATED APPLICATION

This application claims benefit of U.S. Provisional Application Ser. No. 61/528,297 filed Aug. 29, 2011 which is hereby incorporated herein by reference.

### TECHNICAL FIELD

This inventive material relates to the art of mobile commerce, online commerce and online-to-offline (O2O) commerce. Specifically, one particular application is found in conjunction with a mobile telecommunication device used to present alternative payment options and conduct authenticated, dedicated session commercial transactions for customers performing a mobile remote deposit capture (MRDC), and the specification makes particular reference thereto. However, it is to be appreciated that aspects of the present inventive subject matter are also amenable to other like applications.

### BACKGROUND ART

The general purpose of the present inventive subject matter is to provide a system and/or method that enables consumers performing a mobile remote deposit capture (MRDC) to receive real time identification, details and presentation of third party goods and/or services incentive being offered for consideration by the consumer in “exchange” for a dollar amount of equal to or greater than the check remittance funds (i.e. the USD amount the check is written for).

Customers may initiate an MRDC via the following current or potential future systems or like methods such as a native mobile application running on a mobile operating system (i.e. Apple iOS, Google Android, etc.), a potential future digital wallet or eWallet (i.e. Google Wallet) or via a mobile web browser.

This inventive system and/or method enables first party customers to securely purchase items or carry out commercial or other similar transactions using mobile telephones or other similar devices to send and “in-app” message, text, short message service (SMS) message or similar electronic instructions communicating the identification of the third party goods and/or services incentive offer being redeemed in exchange for the check remittance funds.

Commonly, financial institutions (or their proxies) and other institutions involved in money-movement (i.e. PayPal, Google, etc.), employ various channels, e.g., mobile banking application, mobile web browser or similar channels, to enable their customers to perform a MRCD via mobile telephones or similar devices.

However, no commercial transactions are originated from the aforementioned channels for the time-sensitive opportunity presented by the MRCD transaction. Financial institutions, their proxies and merchants are not equipped to interpret or accept an “in-app” message, text, short message service (SMS) message or similar electronic instructions communicating the identification of the third party goods and/or services incentive offer being redeemed in “exchange” for a dollar amount of equal to or greater than the check remittance funds.

Therefore, the present inventive subject matter provides a way in which MRCD transactions may be processed for financial institutions, merchants and their proxies who are otherwise not equipped to interpret an “in-app” message, text, short message service (SMS) message to convey communicating the identification of the third party incentive offers of goods and/or services being redeemed in exchange for the value of the check remittance funds, as well as facilitate commercial transactions thereto.

### DISCLOSURE OF INVENTION

A suitable embodiment of the present inventive subject matter leverages the following legacy systems to present third party merchant incentive offers and enable commercial transactions related thereto, for check deposits being performed via an MRDC application (mobile app) using a mobile or other MRDC enabled device:
a) the current mobile remote deposit capture (MRDC) architecture and mobile app architecture (e.g. BankServ mobile RDC, Mitek Mobile Deposit, BluePoint Mobile Deposit, etc.);
b) the current smart mobile telephone architecture;
c) the current electronic payment methods (e.g. Visa®, MasterCard®, American Express®, Discover®, JCB®, PayPal®, private label accounts, etc.) and;
d) the current processing architectures and legacy payment systems and;
e) the current and evolving mobile payment processing architectures and point-of-sale payment systems and methods such as mFoundry “mPayments”, Google “eWallet”, Visa “digital wallet”, Visa payWave, American Express Wallet, Near Frequency Communication (NFC), mobile tags, action codes, quick response (QR) 2-D barcodes, etc., and;
f) the current and evolving social genome method of organizing and interpreting social media content in order to present information and commercial offers that are relevant to the first party (e.g. Kosmix, etc.), and;
g) the current and evolving Merchant funded incentives processing methods and architectures such as Access Development, Affinity Solutions, Bankons, BillShrink, Cardlytics, Cartera, Clovr Media, Edo Interactive, and Freemonee and;
h) the current and evolving geo-fencing methods and architecture.

In one embodiment, a consumer, in possession of a remittance check payable to them by a third party and a PayPal® or other like payment account, while performing a mobile remote deposit capture (MRDC) is presented with various third party merchant incentives (appearing on the mobile device screen) of equal or greater value than the check remittance funds, initiates a purchase transaction by sending payment instructions via in app message, or via SMS to an SMS short code (or some similar destination identifier) appearing on the mobile device screen. Suitably, the foregoing objected may be accomplished when a system for processing the instructions receives that in-app or SMS message, and passes appropriate information into the merchant's legacy order processing and/or management system. This information can include identifying information about the consumer (e.g., name, address, telephone number), the incentive offering being accepted in exchange for the value of the check remittance funds, as well as suitable payment information (i.e. PayPal® in this example). Suitably, the system also communicates with a payment method processing system or network and returns a request to the consumer via in-app message, or SMS to reply with their password or personal identification number (PIN), thereby helping to ensure the security of the transaction, at which time the payment processing system authorizes the transaction or rejects it based on whether the password and/or PIN is valid, whether sufficient funds are available and/or other considerations. Suitably, the foregoing objected may be accomplished once the authorization and payment process has been completed, notification of the successful or unsuccessful completion of the transaction is passed back to the consumer via an in-app communication, SMS message or similar electronic communication.

In accordance with another embodiment, a consumer, in possession of a remittance check payable to them by a third party, while performing a mobile remote deposit capture (MRDC) is presented with various third party merchant incentives (appearing on the mobile device screen) of equal or greater value than the check remittance funds, initiates a purchase transaction by sending payment instructions via in app message, or via SMS to an SMS short code (or some similar destination identifier) appearing on the mobile device screen. Suitably, the foregoing objected may be accomplished when a system for processing the instructions receives that in-app or SMS message, and passes appropriate information into the merchant's legacy order processing and/or management system. This information can include identifying information about the consumer (e.g., name, address, telephone number), the incentive offering being accepted in exchange for the value of the check remittance funds. In this embodiment, payment is made using the funding account to which the MRCD is deposited. Suitably, the system communicates memo hold instructions to the financial institution or their proxy because, in this embodiment, the owner/operator of this inventive subject matter assumes the payment obligation and associated risk on behalf of the consumer and seeks reimbursement therefor from the financial institution or their proxy from the held or otherwise set aside funds. Suitably, the system also communicates with a payment method processing system or network and returns a request to the owner/operator of the system to reply with their password or personal identification number (PIN), thereby helping to ensure the security of the transaction, at which time the payment processing system authorizes the transaction or rejects it based on whether the password and/or PIN is valid, whether sufficient funds are available and/or other considerations. Suitably, the foregoing objected may be accomplished once the authorization and payment process has been completed, notification of the successful or unsuccessful completion of the transaction is passed back to the owner/operator of the system. The reimbursement from the financial institution from the owner/operator of the system is optionally automatically carried out via an electronic funds transfer or the like. Depending upon the relationship between the parties or agreed upon terms, the foregoing settlement may be conducted on a per transaction basis or in batches at scheduled or otherwise determined intervals.

Alternatively, it is to be appreciated that different aspects of the exemplary embodiments may be selectively employed as appropriate to achieve other alternate embodiments suited for desired applications, the other alternate embodiments thereby realizing the respective advantages of the aspects incorporated herein. For example, a delayed order fulfillment policy may be implemented in order to minimize owner/operator financial risk exposure during check clearing.

### BRIEF DESCRIPTION OF THE DRAWINGS

The present inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration showing a transaction processing system embodying aspects of the present inventive subject matter.

FIG. 2 is a diagrammatic illustration showing an alternate embodiment of a transaction processing system embodying aspects of the present inventive subject matter.

### DETAILED DESCRIPTION OF PREFERRED EMBODIMENTS

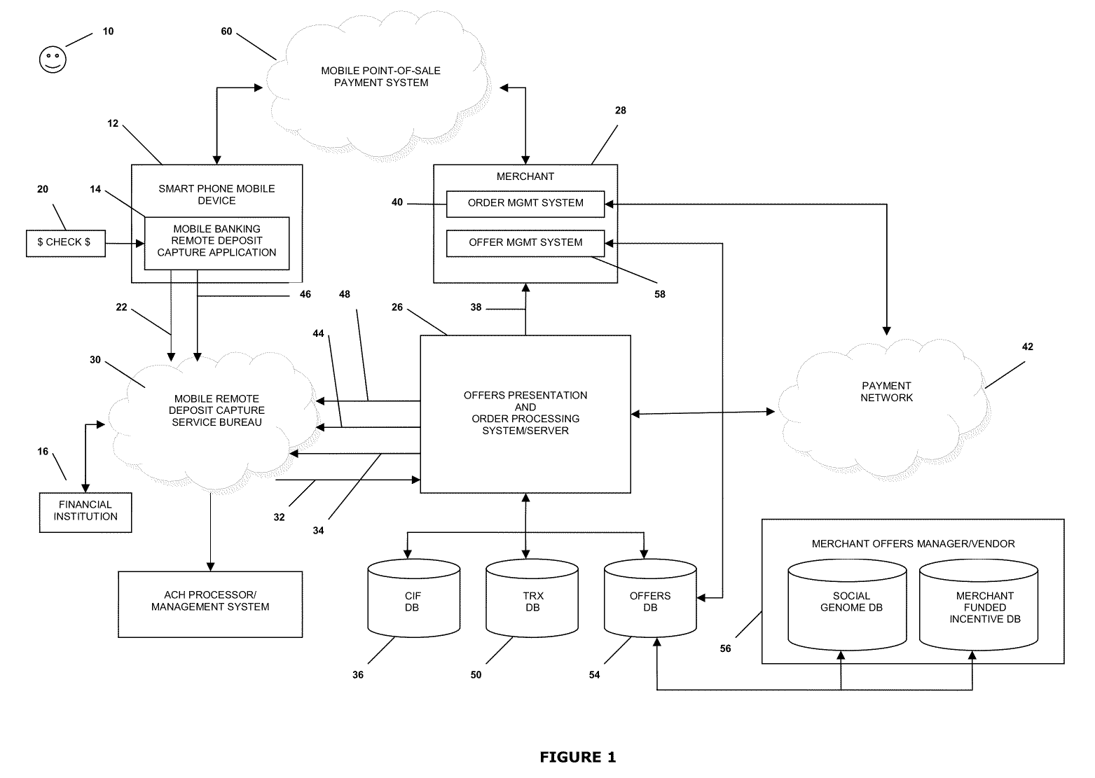

With reference to FIG. 1, a Consumer 10 (which when referred to herein shall include any purchaser) employs a Device 12 to initiate a mobile remote deposit capture (MRDC) routine to deposit Check 20 via a Mobile Banking Remote Deposit Capture Application 14.

The Mobile Banking Remote Deposit Capture Application 14 is offered to Consumer 10 by a Financial Institution 16 or similar institution involved in money-movement and serviced either directly from said institution or via one or more proxies operating a Mobile Remote Deposit Capture Service Bureau 18.

Suitably, while performing a mobile remote deposit capture (MRDC) via a Mobile Banking Remote Deposit Capture Application 14 the Consumer 10 is presented—via real-time presentation from within a Mobile Banking Remote Deposit Capture Application 14 during a dedicated session—with various third party Merchant Incentive Offer 34 (goods and/or services) being offered for consideration by the consumer in exchange for the Check 20 remittance funds and/or USD value of the Check 20 remittance funds.

The Offers Database 54 is optionally accessed to obtain the relevant information for the identified Consumer 10 in order to provide merchant offers that he/she will find meaningful. Accordingly, the Offers Database 54 retrieves or otherwise requests key data from the Merchant Offers Manager/Vendor 56 who maintains and provides social genome and merchant funded incentive information based upon Consumer 10 social and commercial behaviors. For example, upon performing a MRDC routine via Mobile Banking Remote Deposit Capture Application 14, Consumer 10 is presented with relevant Merchant Incentive Offer 34 furnished by Offers Database 54 and based upon information retrieved from Merchant Offers Manager/Vendor 56. Alternatively, the Offers Presentation and Order Processing System 26 also directly connects or otherwise communicates with Merchant Offer Management System 58 to present Consumer 10 with relevant Merchant Incentive Offer 34.

In a suitable embodiment, the Device 12 is a smart mobile telephone or other similar device to send and/or receive an “in-app” Mobile Banking Remote Deposit Capture Application Message 22 communicating the identification of the third party goods and/or services incentive offer being redeemed in exchange for the Check 20 remittance funds and/or USD value of the Check 20 remittance funds.

Suitably, the incentive offer being redeemed in exchange for the Check 20 remittance funds and/or USD value of the Check 20 remittance funds is made by the Consumer 10 appropriately manipulating or otherwise using the Device 12 and Mobile Banking Remote Deposit Capture Application 14 to send an In App Message 22 indicating acceptance of said incentive offer. In the usual manner, when the In App Message 22 is sent, it includes in a header or the like or is otherwise packaged or associated with an origination identifier (ID) that indicates where or which device the message 14 originated from. For example, where the Device 12 is a mobile telephone, the origination ID is optionally the telephone number assigned to or otherwise associated with the Device 12.

As shown in FIG. 1, the In App Message 22 is received by Mobile Remote Deposit Capture Service Bureau 30 which relays the information in real-time via In App Message Relay 32 to an Offers Presentation and Order Processing System 26 that serves the Merchant 28. Alternately, the Offers Presentation and Order Processing System 26 could retrieve or otherwise request key data from the In App Message 22 from the Mobile Remote Deposit Capture Service Bureau 30. Suitably, in this capacity, the Offers Presentation and Order Processing System 26 is implemented and/or functions essentially as a hub for facilitating exchange of Check 20 remittance funds and/or USD value of the Check 20 remittance funds for a Merchant Incentive Offer 34.

Suitably, the Offers Presentation and Order Processing System 26 is implemented as a server or other appropriate computer (including the typical adjunct components thereof, e.g., memory, data storage devices, central processing unit, etc.) that executes software instructions and/or supports one or more computer programs running thereon, so as to carry out the functions, operations and/or processes described herein as being performed by the Offers Presentation and Order Processing System 26.

While FIG. 1 shows the Offers Presentation and Order Processing System 26 serving only one Merchant 28 and one Merchant Offer 34 for purposes of simplicity and clarity herein, it is to be appreciated that the Offers Presentation and Order Processing System 26 in practice serves a plurality of merchants and merchant offers (i.e., one or more) similarly equipped and/or situated.

Suitably, the Offers Presentation and Order Processing System 26 is provisioned with one or more separate Merchant ID and associated Merchant Offer 34 for each merchant served.

Accordingly, the Offers Presentation and Order Processing System 26 differentiates and/or identifies which merchant a particular received Mobile Remote Deposit Capture Service Bureau 30 relates to based upon the particular Merchant ID or other like destination ID to which the Merchant Offer 34 is assigned.

App Message 22 also optionally includes Merchant Offer 34 confirmation, delivery information and/or payment instructions. The Merchant Offer 34 confirmation suitably confirms identify of the Merchant Offer 34 being exchanged for Check 20 remittance funds and/or USD value of the Check 20 remittance funds for a Merchant Incentive Offer 34. The delivery instructions suitably identify an address or other like destination indicating where the purchased products are to be delivered. The payment instructions optionally identify the preferred method of payment indicated by customer 10 from the following two (2) payment options:

a) funds from check 10 being deposited via Mobile Banking Remote Deposit Capture Application 14
b) funds from a type of payment instrument or payment method being used (e.g. Visa®, MasterCard®, American Express®, Discover®, JCB®, PayPal®, a private label account, etc.), a card or account number or a user name associated with the account, a card expiration date, a billing address associated with the payment instrument or account, an account holder's name, etc.

Optionally, the Offers Presentation and Order Processing System 26 includes or otherwise has access to a Customer Information Database 36 in which certain information relating to the Consumer 10 is maintained. Accordingly, by having this information “on file,” it may be omitted from the In App Message 22 as well as In App Message Relay 32. Suitably, the identity of Consumer 10 is optionally confirmed by the Offers Presentation and Order Processing System 26 based upon Merchant Offer 34 acceptance as well as other information provided in the In App Message Relay 32. Additionally, authentication and identification of Consumer 10 is conducted as part of the usual and customary authentication routines performed by Mobile Banking Remote Deposit Capture Application 14. For example, Consumer 10 is authenticated when accessing a Mobile Banking Remote Deposit Capture Application 14 to perform a MRCD for Check 20. Optionally, Customer 10 may be identified based upon the telephone number from which the In App Message 22 originated.

The Customer Information File Database 36 is optionally accessed to obtain the relevant information for the identified Consumer 10, e.g., the consumer's name, their delivery and/or billing addresses, etc. Additionally, the consumer may optionally have one or more payment instruments and/or method associated with their record or file in the Customer Information File Database 36, including the relevant information associated therewith. Accordingly, when the Consumer 10 sends the In App Message 22 he/she may merely have to identify which of the payment instruments/methods on record should be used for the particular purchase if selecting a payment method other than utilizing funds from check 20. Of course, if only one payment instrument/method is on record in the Customer Information File Database 36 for the Consumer 10, then that payment instrument/method and/or its associated payment information may be used by default. Optionally, one of multiple payment instruments/methods on record may be designated as the default, or the default may be to utilize funds from check 20, or finally, there may be no default and Consumer 10 must select payment instrument/method for each Merchant Offer 34 accepted.

In one suitable embodiment, the relevant information to be included in the In App Message 22 by the Consumer 10 is supplied on or in the Mobile Banking Remote Deposit Capture Application 14 along with Merchant Offer 34 which is presented to the Consumer 10 while he/she is performing a MRDC for Check 20 using Device 12. The format of the data, which data is to be included and/or the order in which the data is to be included in the In App Message 22 may be communicated to the Consumer 10 via the Mobile Banking Remote Deposit Capture Application 14, or it may be prearranged or otherwise determined, or some combination thereof.

Upon receipt of the In App Message Relay 32, it is parsed by the Offers Presentation and Order Processing System 26 and the particular information and/or data elements are identified. Therefrom, an appropriate Merchant Offer Order 32 is prepared by the Offers Presentation and Order Processing System 26 and the Merchant Offer Order 32 is submitted to an Order Management System 40 of the Merchant 28. Suitably, the Order Management System 40 is a traditional or legacy order management system into which the Merchant 28 enters traditional MOTO as well as online transactions in the usual manner, and the Merchant Offer Order 32 is submitted directly thereto from the Offers Presentation and Order Processing System 26. Suitably, for the Order Management System 40 to properly process an order, the order preferably includes or contains the relevant purchase or order information/data elements which are organized and/or formatted in a particular manner designated by the particular Order Management System 40. Accordingly, the Offers Presentation and Order Processing System 26 arranges, translates and/or otherwise manipulates the data elements or information received from the In App Message 22 (and/or where appropriate obtained from the Customer Information File Database 36) such that the Merchant Offer Order 32 conforms to the designated format appropriate for the Order Management System 40 to which it is being sent.

As shown in FIG. 1, the Order Management System 40 processes orders and submits the transactions for payment processing in the usual manner to a Payment Network 42 that corresponds to the payment instrument or method employed for the respective Merchant Offer Order 32. Optionally, with certain types of transaction and/or for particular payment methods, the Offers Presentation and Order Processing System 26 is further engaged to assist in the payment processing. For example, some transactions may involve an authentication protocol or initiative prescribed by the Payment Network 42 or the payment method may be such that additional security information or authentication credentials are sought from the Consumer 10 to complete the payment processing. Other payment methods (e.g., PayPal®), similarly may similarly seek authentication credentials (e.g., password, PIN, etc.) from the Consumer 10 prior to authenticating or authorizing a transaction.

In general, the Offers Presentation and Order Processing System 26 retrieves or otherwise requests the desired authentication credentials from the Consumer 10 and returns them to the Payment Network 42. Optionally, any authentication results generated by the Payment Network 42 are then obtained by the Offers Presentation and Order Processing System 26 from the Payment Network 42 and forwarded to the Consumer 10.

With reference to FIG. 1, in a suitable embodiment, the Payment Network 42 signals the Offers Presentation and Order Processing System 26 or the Offers Presentation and Order Processing System 26 is otherwise prompted to obtain authentication credentials from the Consumer 10 if he/she selects a payment method other than utilizing funds from check 20.

In response thereto, the Offers Presentation and Order Processing System 26 sends an In App Payment Authentication Request 44 to the Device 12 (via the Mobile Remote Deposit Capture Service Bureau 30) requesting that Consumer 10 reply with the appropriate credentials (i.e., password, PIN, etc.).

The Consumer 10 then manipulates or otherwise employs the Device 12 to return an In App Payment Credentials Confirmation 46 to the Offers Presentation and Order Processing System 26 (via the Mobile Remote Deposit Capture Service Bureau 30) including therein the requested credentials. Having received the In App Payment Credentials Confirmation 46, the Offers Presentation and Order Processing System 26 parses the In App Payment Credentials Confirmation 46 and/or identifies the credentials returned by the Consumer 10. These returned credentials are then optionally formatted and/or otherwise appropriately arranged as designated or expected by the Payment Network 42 and the credentials are forwarded thereto. Suitably, based on the credentials received by the Payment Network 42 from the Offers Presentation and Order Processing System 26, an authentication and/or authorization determination is made. Optionally, the Offers Presentation and Order Processing System 26 retrieves or otherwise obtains the resulting determination from the Payment Network 42, formats the same into an In App Payment Credentials Decision 48, and forwards the In App Payment Credentials Decision 48 (via the Mobile Remote Deposit Capture Service Bureau 30) to the Device 12 for receipt by the Consumer 10. As can be appreciated from FIG. 1, in connection with any given type of transaction, often multiple In App or other like messages (e.g., messages 22, 32, 34, 44, 46 and 48) are exchanged between the Device 12 and the Offers Presentation and Order Processing System 26 to complete the transaction. Additionally, depending upon the particular type of transaction, there may be an exchange of multiple messages between the Device 12 and the Offers Presentation and Order Processing System 26 before a completed Merchant Offer Order 32 can be submitted to the Order Management System 40.

In one suitable embodiment, the Offers Presentation and Order Processing System 26 includes or otherwise has access to and/or maintains a Transaction Database 50 (TRX DB 50). In the TRX DB 50 various messages exchanged between the Device 12 and the Offers Presentation and Order Processing System 26 are stored, organized and/or grouped, for example, into records or the like according to the particular transaction to which they relate. For example, when the Offers Presentation and Order Processing System 26 receives the In App Message 22 performing a new transaction, it is assigned a unique TRX ID or other like identifier and it is stored or otherwise recorded in the TRX DB 50 under or otherwise indexed by this identifier. Similarly, Merchant Offer 34 and corresponding In App Payment Credentials Decision 48 the corresponding message 52 sent from the Offers Presentation and Order Processing System 26 to the Device 12 is likewise recorded in the TRX DB 50 using the established TRX ID, and so on for messages 32, 34, 44, 46 as well as any other communication during the dedicated session with Consumer 10). In this manner, the plurality of otherwise autonomous messages relating to one particular transaction are linked or chained together. Moreover, based on the particular type of transaction as determined from one or more of the previously exchanged messages corresponding to the same TRX ID, the Offers Presentation and Order Processing System 26 is able to know or predict the form and/or type of message that is expected next for that particular transaction. By linking or otherwise associating messages together in this manner, the Offers Presentation and Order Processing System 26 is able to recognized where in the process a transaction is, i.e., how far the transaction has progressed at a given point in time. For example, at a particular point during a transaction, based upon one or more messages already recorded in the TRX DB 50 under the given TRX ID, the Offers Presentation and Order Processing System 26 knows to expect authentication credentials or some other allowable form or type of reply or message from the Device 12. Moreover, for a given transaction, if an expected message is not received within a set or otherwise determined period of time, the Offers Presentation and Order Processing System 26 may optionally “time out” or otherwise consider that transaction void.

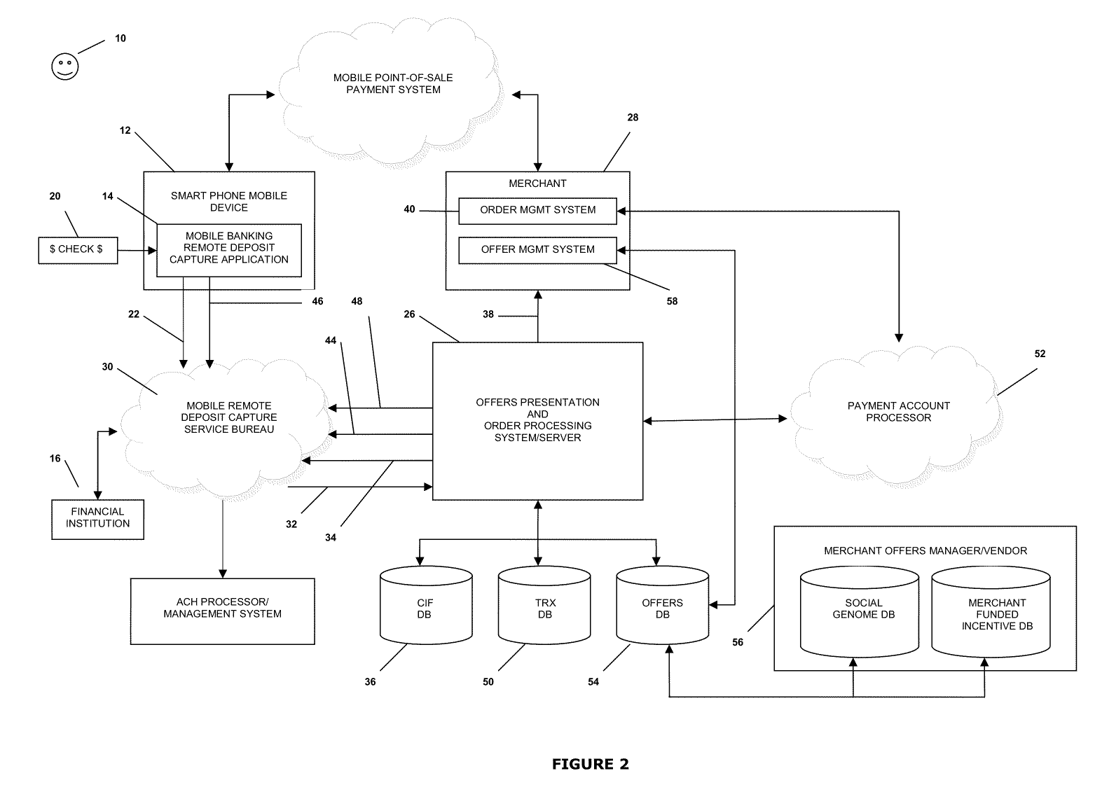

With reference to FIG. 2, suitably the Offers Presentation and Order Processing System 26 is also provisioned to function without accessing the Payment Network 42. For example, as illustrated, the Offers Presentation and Order Processing System 26 directly connects or otherwise communicates with a Payment Account Processor 52 which maintains an account for the Consumer 10. For example, the Payment Account Processor 52 may maintain for the Consumer 10 a prepaid credit card account or a deposit account or other similarly funded account. Alternatively, the Offers Presentation and Order Processing System 26 also directly connects or otherwise communicates with a Payment Account Processor 52 when a Merchant Offer 34 is comprised of an incentive offer for Consumer 10 to transfer Check 20 funds to an eWallet, e-loyalty card, e-gift card or any other electronic instrument capable of being utilized for payment from a mobile device or similar capable of performing a mobile payment via Near Frequency Communication (NFC) or other electronic communication medium in order to execute a commercial transaction for goods and/or services.

Accordingly, when the In App Message 22 is received by the Offers Presentation and Order Processing System 26, if it identifies a payment account maintained by the Payment Account Processor 52, or if the Merchant Offer 34 includes transfer of Check 20 funds to said electronic communication medium as described herein.

If Merchant Offer 34 is a goods and/or services purchase/debit transaction request, then the system communicates with Payment Account Processor 52 to determine if sufficient funds are available to cover the purchase amount. Assuming the payment account is sufficiently funded, the Payment Account Processor 52 is instructed by the Offers Presentation and Order Processing System 26 to set aside the purchase amount from the remainder of the account funds (i.e., to memo hold the funds so as to be otherwise unusable), and the Merchant Offer Order 32 is placed to the Merchant 28. Suitably, the Merchant Offer Order 32 still identifies the delivery destination as corresponding to the Consumer 10 (e.g., either as indicated in the In App Message 22 or as obtained from the CIF DB 36). However, in this embodiment, the owner or operator of the Offers Presentation and Order Processing System 26 assumes the payment obligation (and associated payment risk) on behalf of the Consumer 10 and seeks reimbursement therefor from the Payment Account Processor 52 from the held funds. For example, the payment to the Merchant 28 and the reimbursement from the Payment Account Processor 52 is optionally automatically carried out via an electronic funds transfer or the like. Depending upon the relationship between the parties or agreed upon terms, the foregoing settlement may be conducted on a per transaction basis or in batches at scheduled or otherwise determined intervals.

If Merchant Offer 34 is a gift card purchase/credit transaction request, then the system communicates with Payment Account Processor 52 to determine if an account is maintained for Consumer 10 that corresponds to Merchant Offer 34. For example, if Merchant Offer 34 is an incentive offer to load proceeds from Check 20 onto a retail gift card and Consumer 10 has an existing card with said retailer, then the Payment Account Processor 52 is instructed to load said funds onto said existing retail gift card. If Consumer 10 does not have an existing retail gift card or eGift card account, then the Payment Account Processor 52 is instructed to issue a new retail gift card account and fulfill according to instructions communicated by Offers Presentation and Order Processing System 26.

For example, when Merchant Offer 34 is accepted and proceeds from Check 20 are loaded onto a retail gift card or e-gift card, e-Wallet account or any other electronic instrument may be utilized for payment from a mobile device (i.e. Near Frequency Communication), Consumer 10 may use or otherwise manipulate Device 12 to make payment via a Mobile Point-of-Sale Payment System 60.

Of course, while not explicitly illustrated in FIG. 2, it is to be appreciated that authentication may still be carried out, e.g., optionally in a manner similar to that described with reference to FIG. 1. However, in any case, alternate authentication protocols may also optionally be implemented.

In connection with the particular exemplary embodiments presented herein, certain structural and/or function features are described as being incorporated in particular embodiments. It is to be appreciated that different aspects of the exemplary embodiments may be selectively employed as appropriate to achieve other alternate embodiments suited for desired applications, the other alternate embodiments thereby realizing the respective advantages of the aspects incorporated therein.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to exemplary embodiments. Obviously, modifications and alterations will occur to others upon reading and understanding the present specification. It is intended that the inventive subject matter be construed as including all such modifications and alterations insofar as they come within the scope of the appended claims or the equivalents thereof.

1. A method of conducting a commercial transaction, said method comprising:
a) Responsive to the initiation of a mobile remote deposit capture (MRDC) routine by a customer, a means for Receiving Check, Geographic Location, Device and Payment Instrument Information via “in-app” message, text, short message service (SMS) message or similar electronic communication from within an MRCD application (mobile app) or Financial Institution mobile application messages (in-app message), or similar electronic communication from consumers performing a mobile remote deposit from a smart mobile device or similar device capable of depositing a check remotely to one or more financial institutions and “exchanging” the remittance funds for and/or otherwise purchasing a third party goods and/or services merchant funded incentive offer, including an identification and details of the a) check being deposited via mobile remote deposit, b) identification of a device from which the electronic communication was sent, d) identification of location of the device from which the electronic communication was sent and e) identification and identification of payment instruments resident on said mobile device including eWallet, e-loyalty card, e-gift card or any other electronic instrument capable of being utilized for payment from a mobile device or similar capable of performing a mobile payment via Near Frequency Communication (NFC) or other electronic communication medium;
b) Responsive to Receiving Check, Geographic Location, Device and Payment Instrument Information, a means for Presenting Third Party Merchant Funded Incentive Offers via “in-app” messages, text, short message service (SMS) message or similar electronic communication representing information of at least one third party merchant funded incentive offer, to consumers performing a mobile remote deposit to one or more financial institutions, each of the messages including an identification, details and presentation of the third party goods and/or services merchant funded incentive being offered for consideration by the consumer in “exchange” for the remittance funds and/or otherwise purchase with a conventional payment instrument;
c) Responsive to Presenting Third Party Merchant Funded Incentive Offers, a means for Receiving Confirmation of Acceptance of Merchant Funded Incentive Offer via “in-app” message, text, short message service (SMS) message or similar electronic communication representing acceptance of at least one third party offer, from consumers performing a mobile remote deposit to one or more financial institutions, each of the messages being addressed to an address selected by the consumer if text or delivered via “in-app” messages or similar electronic communication and including an identification and details of the a) acceptance of terms of agreement of acceptance of said third party offer, b) identification of the third party goods and/or services incentive offer being redeemed in “exchange” for the remittance funds and/or otherwise purchase with a conventional payment instrument, c) identification of a device from which the electronic communication was sent and d) identification of location of the device from which the electronic communication was sent;
d) Responsive to Receiving of Confirmation of Acceptance of Merchant Funded Incentive Offer, a means for Parsing Confirmation of Acceptance of Merchant Funded Incentive Offer received via “in-app” message, text, short message service (SMS) message or similar electronic communication to extract the identification and details of a) check being deposited via mobile remote deposit (i.e. dollar value, etc.), b) identification of the third party goods and/or services incentive offer being redeemed in “exchange” for the remittance funds and/or otherwise purchase with a conventional payment instrument, c) the identification of existing payment instruments maintained on the device (i.e. e-gift card, e-wallet, etc.) and d) c) identification of a device from which the electronic communication was sent and d) identification of location of the device from which the electronic communication was sent;
e) Responsive to Receiving Confirmation of Acceptance of Merchant Funded Incentive Offer, a means for Collecting Remittance Funds based upon each received via “in-app” message, text, short message service (SMS) message or similar electronic communication whereby the check remittance funds, which are being deposited to one or more financial institutions via mobile remote deposit, are collected by a service provider as reimbursement for the third party offer accepted by the customer and paid for by system owner/operator on behalf of consumer if he/she is not paying by credit card or similar payment instrument;
f) Responsive to Collecting Remittance Funds, a means for Establishing Payment Instrument and Delivery Information related to a) a payment instrument (e.g. gift card, gift certificate or voucher) and/or data capable of being redeemed for at least one good or service provided by the third party such as an electronic code, promotional number, gift certificate number, or any other data capable of being communicated to the customer, b) physical or non-physical (i.e. email, etc.) address delivery information indicating where the funds are to be submitted or payment instrument be delivered, and c) routing and account number details for account where the MRDC is being deposited to in order to facilitate reimbursement for select transactions;
g) Responsive to Establishing Payment Instrument and Delivery Information, a means for Generating an Order for each received via “in-app” message, text, short message service (SMS) message or similar electronic communication including information of a) identification of the third party goods and/or services incentive offer being redeemed in “exchange” for the remittance funds and/or otherwise purchase with a conventional payment instrument, b) the incentive offer payment instrument selected, and c) remittance funds routing information or physical and/or non-physical address delivery information indicating where the funds are to be submitted or payment instrument be delivered;
h) Responsive to Generating an Order, a means for Submitting an Order to Merchant for the third party goods and/or services incentive offer being redeemed in “exchange” for the remittance funds and/or otherwise purchase with a conventional payment instrument, to a payment instrument order management system of the merchant;
i) Responsive to Submitting and Order to Merchant, a means for Delivering an Order Confirmation via “in-app” message, text, short message service (SMS) message or similar electronic communication to the customer information specific to the acceptance of the third party goods and/or services incentive offer being redeemed in “exchange” for the remittance funds and/or otherwise purchase with a conventional payment instrument.

2. The method of claim 1, responsive to an order being received by the Offers Presentation and Order Processing System/Server (“Order System”), the Order System submits a corresponding payment for processing to a payment processing network (“Payment Network”) if consumer chooses to pay by credit card or similar payment instrument.

3. The method of claim 1, responsive to an order being received by the Offers Presentation and Order Processing System/Server (“Order System”), the Order System submits a corresponding debit instruction for processing to a ACH processing network and/or mobile remote deposit capture service bureau (“Service Bureau”) if consumer chooses to pay with deposit account to which the check has been deposited via MRCD.

4. The method of claim 1, responsive to the consumer initiation of a mobile remote deposit capture (MRDC) routine being received by the Offers Presentation and Order Processing System/Server (“Order System”), the Order System submits various third party merchant incentive offers for display to customer via mobile device to a Service Bureau.

5. The method of claim 4, said method further comprising: (j) receiving a signal from a merchant offers manager vendor (“Offer Vendor”); (k) generating in response to the received signal an in-app message, text message, SMS message or similar electronic communication presenting merchant funded incentive offers based upon information provided by the Offer Vendor; (l) sending the in-app message generated in step (k) to the device of the first party either directly or via a Service Bureau.

6. The method of claim 2, said method further comprising: (l) receiving a signal from the Payment Network in response to the submitted payment instruction; (m) generating in response to the received signal an in-app message, text message, SMS message or similar electronic communication requesting authentication credentials; (n) sending the in-app message generated in step (m) to the device of the first party either directly or via a Service Bureau; (m) receiving an in-app message reply containing authentication credentials from the first party's device either directly or via a Service Bureau; and, (o) forwarding the received authentication credentials to the Payment Network.

7. The method of claim 3, said method further comprising: (l) receiving a signal from the Service Bureau in response to the submitted debit instruction; (p) processing to a payment processing network (“Payment Network”) from the Order System for a corresponding payment.

8. The method of claim 1, further comprising: maintaining a database of information for a plurality of first parties associated with respective smart mobile device and MRDC and/or Financial Institution App identifications, including a record for each first party containing a list of one or more payment instruments belonging to that first party and American Bankers Association (“ABA”) routing and transit number and account number for account to which the check is being deposited via the MRDC.

9. The method of claim 1, wherein the established delivery information is based upon the identification of the device received in step (a).

10. The method of claim 1, wherein the message is received via relay (i.e. via secure VPN, etc.) from a mobile application service bureau supporting a dedicated mobile banking/mobile remote deposit application session.

11. The method of claim 1, wherein the payment instrument selected in step (f) is identified in the electronic/in-app message received in step (a).

12. The method of claim 1, further comprising: maintaining a database of information for a plurality of first parties associated with respective device identifications, including a record for each first party containing the delivery information for that first party.

13. The method of claim 1, wherein the delivery information is identified in the in app message received in step (f).

14. The method of claim 1, wherein the payment instrument selected in step (f) is identified in the mobile remote deposit application/mobile banking message received in step (a).

15. The method of claim 1, said method further comprising: responsive to step (a), providing one or more merchant funded incentive offers for the purchase of a product and or service in a media received by the first party, said offer identifying how to purchase and pay for the product and or service using proceeds from the check being deposited or a credit card or other similar payment instrument.

16. The method of claim 15, wherein the media is a mobile device and mobile banking remote check deposit application user interface.

17. The method of claim 11, wherein step (f) comprises: selecting the payment instrument from the record in the database corresponding to the first party associated with the identification of the device extracted in step (d).

18. The method of claim 8, wherein step (f) comprises: obtaining the delivery information from the record in the database corresponding to the first party associated with the identification of the device extracted in step (d).

19. A mobile remote deposit application/mobile banking message order processing system comprising: a computer server including memory, data storage devices and a central processing unit that is operable to: receive mobile remote deposit application/mobile banking message messages from consumers purchasing products from one or more merchants, each of said mobile remote deposit application/mobile banking message messages including an identification of the merchant funded incentive offer being purchased and an identification of a device from which the mobile remote deposit application/mobile banking message was sent; parse each mobile remote deposit application/mobile banking message to extract the identification of the product and the identification of the device from the mobile remote deposit application/mobile banking message; select based upon each received mobile remote deposit application/mobile banking message a payment instrument to be used to pay for the purchase; establish payment information related to the selected payment instrument and delivery information indicating where the purchased product is to be delivered; generate for each received mobile remote deposit application/mobile banking message an order including the established payment information, delivery information and identification of the merchant funded incentive offer being purchased; and, submit the generated order to an order management system of the merchant.

20. The mobile remote deposit application/mobile banking message order processing system of claim 19, wherein the merchant offer code included in the mobile remote deposit application/mobile banking message is used to identify the order management system of the merchant to which the order is to be submitted.
